(19) United States
(12) Patent Application Publication
(10) Pub. No.: US 2009/0161596 A1
(43) Pub. Date: Jun. 25, 2009

(54) METHOD AND SYSTEM FOR TRANSMITTING MULTIMEDIA BROADCAST/MULTICAST SERVICE

(75) Inventors: Junwei WANG, Shenzhen (CN); Xiao ZHOU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/394,895

(22) Filed: Feb. 27, 2009

Related U.S. Application Data
(63) Continuation of application No. PCT/CN2007/070599, filed on Aug. 30, 2007.

(30) Foreign Application Priority Data
Sep. 1, 2006 (CN) 200610127731.8

(51) Int. Cl. H04H 20/71

(52) U.S. Cl. 370/312

(57) ABSTRACT

A method for transmitting multimedia broadcast/multicast service includes: checking whether packet loss occurs during a transmission process of the multimedia broadcast/multicast service; and notifying, upon checking a packet loss, a physical layer not to transmit any data over a time and frequency resource used for transmitting the lost packet. A system for transmitting multimedia broadcast/multicast service is also provided. The method and system realizes checking and handling the packet loss during transmission process of MBMS service in time, effectively prevents errors from spreading, guarantees that terminals can receive MBMS service data correctly and further ensures smooth radio combining in the physical layer.

### CROSS-REFERENCE TO RELATED APPLICATIONS

This application is a continuation of International Patent Application No. PCT/CN2007/070599, filed Aug. 30, 2007, which claims priority to Chinese Patent Application No. 200610127731.8 filed on Sep. 1, 2006, both of which are hereby incorporated by reference in their entirety.

### FIELD OF THE INVENTION

The present invention relates to communication, especially to a method and system for transmitting multimedia broadcast/multicast service.

### BACKGROUND

For efficient use of mobile communication network resources, the third Generation Partnership Project (3GPP) proposes Multimedia Broadcast/Multicast Service (MBMS) over the mobile communication network. The MBMS mainly refers to that the network transmits the same multimedia data to multiple receptors in the network. The MBMS as proposed by 3GPP cannot only be used to realize multicast and broadcast of low rate plain text message, but also be used to realize multicast and broadcast of high speed multimedia service, hence conforming to the future development trend of mobile data communication.

In the 3GPP Long Term Evolution (3GPP LTE) project, MBMS is an important service. In order to simplify the design of network structure, a concept of downlink single carrier is proposed nowadays, which means a carrier is separated for only transmitting MBMS and related control data while unicast data are not transmitted in the dedicated carrier. By using the separate downlink only carrier, systems operate on the same frequency, and all eNodeBs (Base Stations) transmit the same MBMS services synchronously. That is to say, a synchronized broadcast of same content as well as same modulating and encoding mode is realized. FIG. 1 shows a network architecture for transmitting MBMS packet according to the LTE.

In FIG. 1, several eNodeBs are under the control of an access gateway (AGW). Packets destined to the eNodeBs are forwarded to Radio Link Control (RLC) entities of the eNodeBs from a Packet Data Convergence Protocol (PDCP) entity of the AGW. In this network, the AGW as a forwarding node at least has the PDCP function and the eNodeB as a transmitting node at least has the RLC function. The RLC protocol has a function of providing segmentation and retransmission services for users and control data. RLC entities are configured with Radio Resource Control (RRC) and operate in one of three modes, namely Transparency Mode (TM), Unacknowledged Mode (UM), and Acknowledged Mode (AM). In WCDMA, the RLC entity operates in the UM for the MBMS. Functions of RLC layer include segmentation, recombination, cascade and encryption.

FIG. 2 shows a process for two peer RLC entities to transmit MBMS in the Unacknowledged Mode.

At the transmitting side, a transmitting Unacknowledged Mode Radio Link Control (UM-RLC) entity receives MBMS RLC Service Data Units (MBMS RLC SDUs) from a higher layer via an Unacknowledged Mode Service Access Point (UM-SAP). If the length of an RLC SDU is longer than the length of an Unacknowledged Mode Data Packet Data Unit (UMD PDU), the transmitting UM-RLC entity may segment the RLC SDU into multiple UMD PDUs of proper size. The UMD PDU may contain multiple segmented or cascaded RLC SDUs, and may be filled to ensure its effective length.

If encryption is enabled in the system, UMD PDUs may be encrypted (except for headers of the UMD PDUs) before they are transferred to a lower layer.

At the receiving end, a receiving UM-RLC entity receives the UMD PDUs from the lower layer via configured logic channels. The received packets may be added or deleted without changing contents in buffer.

If encryption is enabled in the system, the receiving UM-RLC entity may decrypt (if encryption function is already configured) the received UMD PDUs (except for the UMD PDU headers), remove RLC headers from the received UMD PDUs, and recombine the UMD PDUs into RLC SDUs.

There are disadvantages in the above-mentioned process for transmitting MBMS packet. When MBMS packets are transmitted downward from the PDCP to the RLC layer, packet loss might occur. However, there is no error detection and correction functions in conventional art solutions, once an error occurs, the radio combining in physical layer cannot take place smoothly.

### SUMMARY

Embodiments of the present invention provide a method and system for transmitting multimedia broadcast/multicast service. The present invention overcomes the problem of transmission errors caused from packet loss during MBMS service transmission process.

The present invention is implemented by the following embodiments.

An embodiment of the present invention provides a method for transmitting multimedia broadcast/multicast service, which includes: checking whether a packet loss occurs during a transmission of the multimedia broadcast/multicast service; and notifying, upon losing a packet, a physical layer not to transmit any data over a time and frequency resource used for transmitting the lost packet.

An embodiment of the present invention provides a system for transmitting multimedia broadcast/multicast service, the system includes a packet forwarding node and a packet transmitting node, and the system further includes: a packet loss checking module adapted to check whether a packet loss occurs during a transmission of packets; and a packet loss handling module adapted to notify, upon checking a packet loss by the packet loss checking module, a physical layer not to transmit any data over a time and frequency resource used for transmitting the lost packet.

In the technical solutions provided in the embodiments of the present invention, by providing the packet loss checking module and the packet loss handling module, embodiments of the present invention realize checking and handling timely packet loss during transmission process of MBMS service, effectively prevents errors due to packet loss from spreading, guarantees that the terminals can receive MBMS service data correctly and thus ensures radio combining in the physical layer.

### BRIEF DESCRIPTION OF THE DRAWINGS

FIG. 1 is a schematic diagram illustrating a network architecture for transmitting MBMS packets according to conventional art LTE;

FIG. 2 is a schematic diagram illustrating the transmission of MBMSs between two peer RLC entities in Unacknowledged Mode;

FIG. 3 is a schematic diagram illustrating a method for processing MBMS data according to a first embodiment of the present invention;

FIG. 4 is a flowchart diagram illustrating operations of the method according to the first embodiment of the present invention;

FIG. 5 is a schematic diagram illustrating a method for processing MBMS data according to a second embodiment of the present invention;

FIG. 6 is a block diagram illustrating a system according to an embodiment of the present invention;

FIG. 7 is a block diagram illustrating a packet loss checking module according to a first embodiment of the present invention;

FIG. 8 is a block diagram illustrating a packet loss checking module according to a second embodiment of the present invention; and

FIG. 9 is a block diagram illustrating a packet loss checking module according to a third embodiment of the present invention

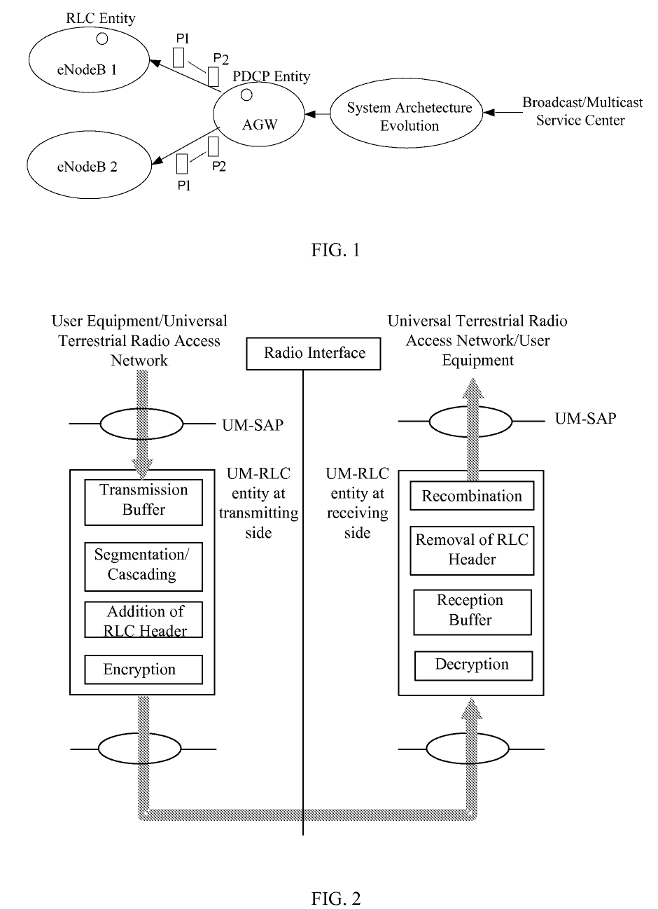

### DETAILED DESCRIPTION

Embodiments of the present invention provide a method and system for transmitting multimedia broadcast/multicast service. It is checked, during the process of transmitting MBMS data, whether packet loss occurs in the process of transmission. Upon detecting a packet loss, countermeasures are carried out in time, so as to effectively prevent error from spreading and ensure terminals to correctly receive MBMS service data.

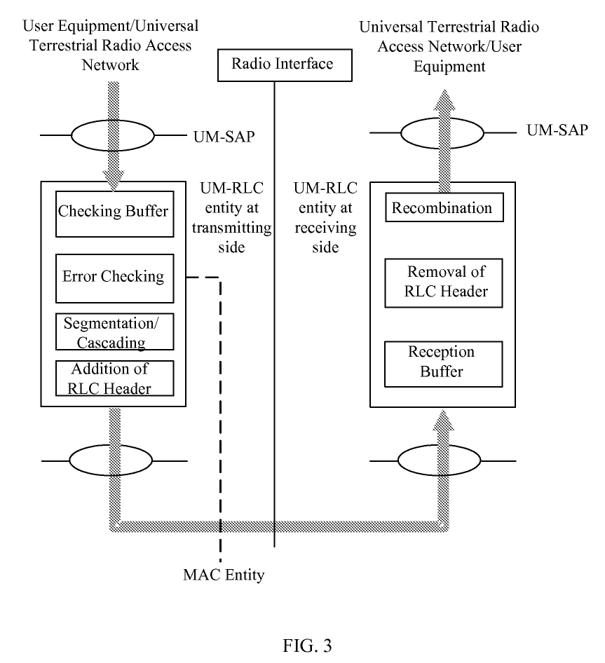

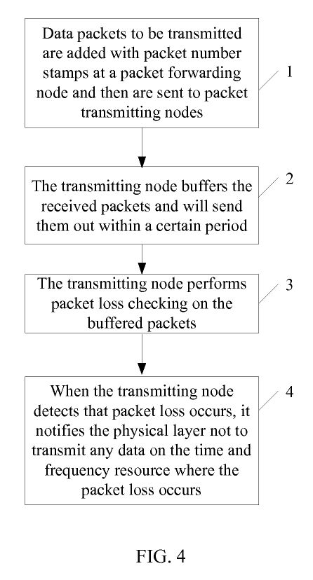

FIG. 3 is a schematic diagram illustrating a method for transmitting MBMS data between an RLC entity at transmitting side and a peer RLC entity at receiving side over the downlink single carrier, according to a first embodiment of the present invention. FIG. 4 shows the specific operation flow of the method, comprising the following steps.

Step 1: Data packets to be transmitted are set with packet number stamps at a packet forwarding node, and the data packets are sent to packet transmitting nodes.

Packets to be transmitted to users are set with packet number stamps at the packet forwarding node such as an AGW. The packet number stamps are used as a reference for the transmitting nodes such as eNodeBs to check packet loss.

Step 2: The transmitting node buffers the received packets, and sends them within a certain period.

The transmitting node includes a checking buffer which is new added. It is obvious for those skilled in the art that the checking buffer may be provided in a special layer of the node, such as in a synchronization (SYNC) sub-layer. The checking buffer is used to buffer data sent from the forwarding node in order to avoid missing transmission of packets due to transmission jitter. The checking buffer can accommodate at least two packets.

Packets sent by the forwarding node are first sent into the checking buffer for a temporary buffering. The checking buffer conducts data buffering process and sends the packets in a certain period. After one packet is sent, the checking buffer is updated to receive the next packet.

Step 3: The transmitting node performs packet loss checking on the buffered packets.

The transmitting node includes a packet loss checking module which is new added. It is obvious for those skilled in the art that the packet loss checking module may be provided in a special layer of the node, such as in the synchronization (SYNC) sub-layer. After packets are sent from the checking buffer to the packet loss checking module, the packet loss checking module sorts the received packets according to their packet number stamps. By means of the sorting, the RLC can check whether packet loss occurs.

Before the sorted packets are sent, the packet number stamps are removed from the packets and then the packets are subjected to subsequent process such as segmentation, cascading and so on.

Step 4: Upon detecting a packet loss by the transmitting node, it notifies the physical layer not to transmit any data on the time and frequency resource where the packet loss occurs.

Upon detecting the loss of packet by the transmitting node, the RLC entity in the transmitting node such as an eNodeB notifies the physical layer not to transmit any data on the time and frequency resource where the packet loss occurs, in which the pilot signals for the lost packets are not transmitted either.

The transmitting node may notify the physical layer directly, or may notify the Media Access Control (MAC) layer, and then the MAC layer notifies the physical layer not to transmit any data. The method for the MAC layer notifying the physical layer includes the following: the MAC layer may notify the physical layer not to transmit any data; or, at the time of packet loss, the MAC layer transmits a set of random data to the physical layer, and notifies the physical layer not to map, after processing the random data, the processed signals to the time and frequency resources where the lost packets are to be received, that is to say, the physical layer maps zero power to the time and frequency resources where the lost packets are to be received.

The transmitting node waits until the arrival of the next time for transmitting the next packet, and transmits the next packet at the same time with other several base stations in several cells.

A specific example is provided hereafter.

When the MBMS service is transmitted in Multi-cell manner, all MBMS packets that each of the cells should transmit are P1, P2, P3, P4, P5 . . . . The forwarding node adds an additional packet number stamp to each of the packets sent from each of the cells, and then sends the packets to the packet transmitting node. The transmitting node buffers the received packets and then sorts the packets. By means of the sorting, the transmitting node recognizes the loss of some of the packets transmitted by cell 2. As shown in the table below, the packets transmitted by cell 2 are P1, P3, P4, P5, . . . . At the second time, cell 2 does not transmit any data on the time and frequency resources (data frames). Having sorted the received packets, the transmitting node removes packet headers from the normally received packets, sends the packets, and notifies the physical layer not to transmit any data on the time and frequency resources where the packet loss occurs. The transmitting node waits until the arrival of the next time for transmitting the next packet, and transmits the next packet at the same next time with other base stations in several cells. As shown in the table below, cell 2 waits for the arrival of the third time to transmit the packet 3 at the same frequency and time with other cells.

| | Transmitting Time | | | | |
|---|---|---|---|---|---|
| | 1 | 2 | 3 | 4 | 5 |
| Cell 1 | P1 | P2 | P3 | P4 | P5 |
| Cell 2 | P1 | — | P3 | P4 | P5 |

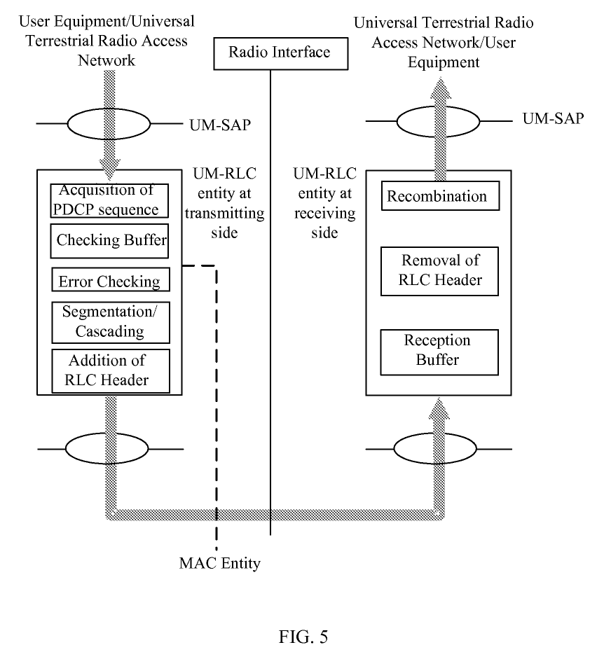

FIG. 5 is a schematic diagram illustrating a method for transmitting MBMS service between an RLC entity at transmitting side and a peer RLC entity at receiving side over the downlink only carrier, according to a second embodiment of the present invention. In this embodiment, an internal header number, i.e., PDCP sequence, of the PDCP entity in the forwarding node is used as a reference for sorting by the transmitting node, that is, after the transmitting node buffers packets received from the forwarding node, the transmitting node identifies the PDCP sequence in the front bits of packets, sorts the received packets according to the PDCP sequence, and recognizes whether any packet is lost according to the sorting. Upon recognizing a packet loss, the same process as described in the first embodiment is conducted subsequently.

A method according to the third embodiment of the present invention is given below. In this embodiment, if packet loss occurs during the transmission of packets from the forwarding node to the transmitting node over the Transport Network (TN), the TN notifies the transmitting node of the length of the lost packet in time. This notification may be sent to the transmitting node along with the packet to be sent to the transmitting node at the next time, and is used to indicate the transmitting node that a packet of length L is lost prior to the reception of current packet by the transmitting node, wherein the length L is the length of the lost packet. If some packet is lost during the TN transmits packets, the TN may know the length of the lost packet.

Upon receiving the notification, the transmitting node conducts the same process as described in the first embodiment.

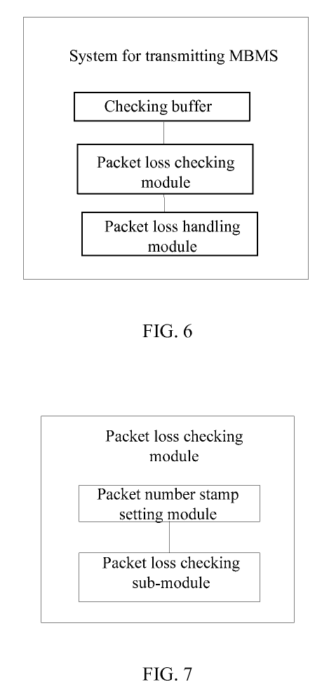

The present invention provides a system for transmitting multimedia broadcast/multicast service. As shown in FIG. 6 illustrating a block diagram of the system, the system includes a packet loss checking module, a checking buffer and a packet loss handling module. It is apparent for those skilled in the art that the packet loss checking module and the checking buffer may be provided in a special layer, such as in SYNC sub-layer. The packet loss checking module checks whether packet loss occurs in the process of transmitting packets. As shown in FIG. 7, the packet loss checking module according to an embodiment includes.

A packet number stamp setting module adapted to set a packet number stamp in the head of a packet. The packet number stamp setting module may be provided at the packet forwarding node, for example, may be provided at a PDCP entity of a forwarding node such as an AGW.

A packet loss checking sub-module adapted to sort received packets according to the packet number stamps set by the packet number stamp setting module, and check whether some packet is lost according to the sorting, so as to determine whether packet loss occurs during packet transmission. The packet loss checking sub-module may be provided at the packet transmitting node, for example, may be provided at an RLC entity of an eNodeB.

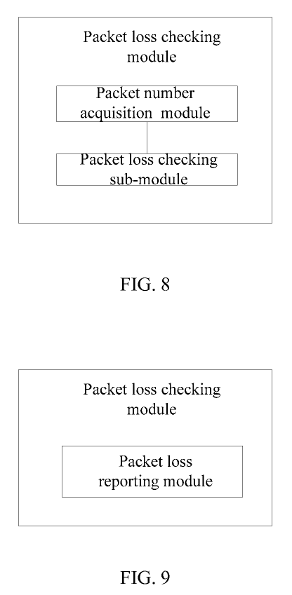

As shown in FIG. 8, the packet loss checking module according to a second embodiment includes.

A packet number acquisition module adapted to acquire forwarding node sequence numbers carried in received packets; the forwarding node sequence numbers are used as a reference for the packet loss checking module to perform sorting;

A packet loss checking sub-module adapted to sort the received packets according to the forwarding node sequence numbers acquired by the packet number acquisition module, and check whether some packet is lost according to the sorting, so as to determine whether packet loss occurs during packet transmission.

The packet number acquisition module and the packet loss checking sub-module may be provided at the packet transmitting node, for example, may be provided at an RLC entity of an eNodeB.

As shown in FIG. 9, the packet loss checking module according to a third embodiment includes.

A packet loss reporting module adapted to report packet loss information to the packet transmitting node upon losing a packet during the transmission of packets between the forwarding node and the transmitting node over a transport network TN. The packet loss reporting module may be provided at the transport network. The packet loss information includes the length of the lost packet, and may be sent to the transmitting node along with the next packet to be transmitted to the transmitting node at the next time.

The packet loss handling module controls the physical layer not to transmit, at the time of packet loss, any data over the time and frequency resource where the packet loss occurs, upon detecting a packet loss during transmission of packets. The method for controlling the physical layer not to transmit any data includes: the packet loss handling module directly notifies the physical layer not to transmit any data; alternatively, the packet loss handling module notifies the MAC layer, then the MAC layer notifies the physical layer not to transmit any data. The method for the MAC layer to notify the physical layer includes: the MAC layer notifies the physical layer not to transmit any data; alternatively, at the time of packet loss, the MAC layer transmits a set of random data to the physical layer, and notifies the physical layer not to map, after processing the random data, the processed signals to the time and frequency resources where the lost packets are to be received, that is to say, the physical layer maps zero power to the time and frequency resources where the lost packets are to be received.

The checking buffer is provided in the transmitting node and is adapted to buffer data sent from the forwarding node to the transmitting node, so as to avoid missing of packets due to transmission jitter. The checking buffer can accommodate at least two packets.

According to the present invention, packet loss checking and handling may be performed timely in the process of MBMS service transmission, so that it is effectively ensured that the terminals can receive MBMS service data correctly and hence ensures smooth radio combining in the physical layer.

The above description only illustrates preferred specific embodiments of the present invention; the scope of the present invention is not limited to the embodiments. It is apparent for those skilled in the art to make variations and replacements on the embodiments without departing from the scope of the present invention, and the invention intends to cover such variations and replacements. The protection scope of the present invention is only defined by the claims.

1. A method for transmitting multimedia broadcast and multicast service comprising:
checking whether a packet loss occurs during a transmission of the multimedia broadcast and multicast service; and
notifying, upon losing a packet, a physical layer not to transmit any data over a time and frequency resource used for transmitting the lost packet.

2. The method for transmitting multimedia broadcast and multicast service of claim 1, wherein said checking whether a packet loss occurs comprises:
setting packet number stamps in headers of packets to be transmitted; and
sorting received packets according to the packet number stamps to determine whether the packet loss occurs.

3. The method for transmitting multimedia broadcast and multicast service of claim 2, further comprising removing the packet number stamps and transmitting the packets.

4. The method for transmitting multimedia broadcast and multicast service of claim 1, wherein said checking whether a packet loss occurs comprises sorting packets according to inherent forwarding node sequence numbers in the packets to determine whether the packet loss occurs.

5. The method for transmitting multimedia broadcast and multicast service of claim 1, wherein a network system providing the multimedia broadcast and multicast service includes a transport network, a forwarding node and a transmitting node, and wherein said checking whether a packet loss occurs in the network system comprises:
sending, by the transport network, a notification of packet loss information to the transmitting node during a transmission of the packet from the forwarding node to the transmitting node through the transport network.

6. The method for transmitting multimedia broadcast/multicast service of claim 1, further comprising buffering received packets before checking the packet loss.

7. The method for transmitting multimedia broadcast and multicast service of claim 1, wherein said notifying a physical layer not to transmit any data comprises:
notifying one of the physical layer and a Media Access Control (MAC) layer not to transmit data over the time and frequency resource used for transmitting the lost packet.

8. The method for transmitting multimedia broadcast and multicast service of claim 2, wherein said notifying a physical layer not to transmit any data comprises:
notifying one of the physical layer and a Media Access Control (MAC) layer not to transmit data over the time and frequency resource used for transmitting the lost packet.

9. The method for transmitting multimedia broadcast and multicast service of claim 3, wherein said notifying a physical layer not to transmit any data comprises:
notifying one of the physical layer and a Media Access Control (MAC) layer not to transmit data over the time and frequency resource used for transmitting the lost packet.

10. The method for transmitting multimedia broadcast and multicast service of claim 4, wherein said notifying a physical layer not to transmit any data comprises:
notifying one of the physical layer and a Media Access Control (MAC) layer not to transmit data over the time and frequency resource used for transmitting the lost packet.

11. The method for transmitting multimedia broadcast and multicast service of claim 7, wherein the MAC layer further notify the physical layer not to transmit the data over the time and frequency resource used for transmitting the lost packet, and the method further comprising one of:
sending, by the MAC layer, no data to the physical layer for the time of a packet loss; and
sending, by the MAC layer, a set of random data to the physical layer, and notifying the physical layer to map, after processing the random data, zero power for the processed random data to the time and frequency resources where the lost packets are to be received.

12. The method for transmitting multimedia broadcast and multicast service of claim 7, wherein said data further comprises a pilot signal of the lost packet.

13. A system for transmitting multimedia broadcast and multicast service comprising a packet forwarding node and a packet transmitting node, wherein the system further comprises:
a packet loss checking module adapted to check whether packet loss occurs during a transmission of packets; and
a packet loss handling module adapted to notify, upon checking a loss of packets by the packet loss checking module, a physical layer not to transmit data over a time and frequency resource used for transmitting the lost packet.

14. The system for transmitting multimedia broadcast and multicast service of claim 13, wherein the packet loss checking module comprises:
a packet number setting module adapted to set packet number stamps in headers of packets to be transmitted; and
a packet loss checking sub-module adapted to sort received packets according to the packet number stamps to determine whether a packet loss occurs according to the sorting.

15. The system for transmitting multimedia broadcast and multicast service of claim 13, wherein the packet loss checking module further comprises:
a packet number acquisition module adapted to acquire forwarding node sequence numbers of received packets; and
a packet loss checking sub-module adapted to sort the received packets according to the forwarding node sequence numbers, to determine whether a packet loss occurs during the transmission of the packets according to the sorting.

16. The system for transmitting multimedia broadcast and multicast service of claim 13, wherein the packet loss checking module further comprises a packet loss reporting module adapted to report, upon losing a packet during a transmission of packets, packet loss information to the packet transmitting node receiving the packets.

17. The system for transmitting multimedia broadcast and multicast service of claim 16 wherein the reported packet loss information comprises the length of a lost packet.

18. The system for transmitting multimedia broadcast and multicast service of claim 13, wherein the system further comprises a checking buffer adapted to buffer packets transmitted from the packet forwarding node.

19. The system for transmitting multimedia broadcast and multicast service of claim 18, wherein the checking buffer includes at least two packets.

20. The system for transmitting multimedia broadcast and multicast service of claim 14, wherein the system further comprises a checking buffer adapted to buffer packets transmitted from the packet forwarding node.
